(19) United States
(12) Patent Application Publication
(10) Pub. No.: US 2026/0048286 A1
(43) Pub. Date: Feb. 19, 2026

(54) CONTAINMENT ARRANGEMENT FOR USE WITH A PRESCRIBED BURN APPARATUS

(71) Applicant: Waleed Sami Haddad, San Francisco, CA (US)

(72) Inventor: Waleed Sami Haddad, San Francisco, CA (US)

(21) Appl. No.: 18/805,044

(22) Filed: Aug. 14, 2024

(51) Int. Cl. A62C 3/02

(52) U.S. Cl. CPC A62C 3/0278

(57) ABSTRACT

An apparatus configured to perform a prescribed burn of vegetative ground fuel comprises a movable platform configured to traverse ground that contains the vegetative ground fuel and a burn chamber disposed on the movable platform. A containment arrangement is situated relative to the burn chamber and configured to confine burning of the vegetative ground fuel to a prescribed burn region of the ground. The containment arrangement comprises an arrangement of interleaved plates having two or more different shapes and connected together via link members. A discharge apparatus is configured to expel residual effluent from the burn chamber.

### BACKGROUND

Worldwide, wildfires are becoming more destructive and costly, with cascading impacts on forest health, community well-being, and public infrastructure. Increasingly destructive wildfire behavior has been attributed to excessive fuel loads in forests and the Wildland-Urban Interface—an outcome of a century-old fire suppression strategy coupled with a warming climate.

### SUMMARY

One or more embodiments are directed to an apparatus configured to perform a prescribed burn of vegetative ground fuel. The apparatus comprises a movable platform configured to traverse ground that contains the vegetative ground fuel, and a burn chamber disposed on the movable platform. A containment arrangement is situated relative to the burn chamber and configured to confine burning of the vegetative ground fuel to the prescribed burn region. The containment arrangement comprises an arrangement of interleaved plates having two or more different shapes and connected together via link members. A discharge apparatus is positioned relative to the burn chamber and configured to expel residual effluent from the burn chamber.

One or more embodiments are directed to an apparatus configured to perform a prescribed burn of vegetative ground fuel. A movable platform is configured to traverse ground that contains the vegetative ground fuel. The movable platform comprises a front end and a rear end opposing the front end. A burn chamber is disposed on the movable platform and comprises a front end, a rear end opposing the front end, a first side, and a second side opposing the first side. A containment arrangement is situated relative to the burn chamber and configured to confine burning of the vegetative ground fuel to a prescribed burn region of the ground. The containment arrangement comprises a front skirt situated proximate the front end of the burn chamber, a rear skirt situated proximate the rear end of the burn chamber, a first side skirt situated proximate the first side of the burn chamber, and a second side skirt situated proximate the second side of the burn chamber. A plurality of rollers are situated at the rear end of the movable platform. The plurality of rollers comprise a first end roller and a second end roller opposing the first end roller. A first roller skirt is situated proximate the rear skirt. A first extender skirt is situated rearward of the first roller skirt and proximate the first end roller. A second extender skirt is situated rearward of the first roller skirt and proximate the second end roller. Each of the respective skirts comprises an arrangement of interleaved plates having two or more different shapes and connected together via link members. A discharge apparatus is configured to expel residual effluent from the burn chamber.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1A is a perspective view of an apparatus configured to perform a prescribed burn of vegetative ground fuel in accordance with any of the embodiments disclosed herein;

FIG. 1B is a side view of the apparatus shown in FIG. 1A;

FIG. 1C is a top view of the apparatus shown in FIG. 1A;

FIG. 1D is a rear view of the apparatus shown in FIG. 1A;

FIG. 2 is an illustration showing skirts of non-flammable plates disposed proximate a burn chamber and a roller arrangement shown in FIG. 1A in accordance with any of the embodiments disclosed herein;

FIG. 3A illustrates details of a representative skirt comprising non-flammable plates in accordance with any of the embodiments disclosed herein;

FIG. 3B illustrates details of a non-flammable plate having a hexagonal shape;

FIG. 3C illustrates details of a non-flammable plate having a diamond shape;

FIG. 4 illustrates details of a portion of a representative skirt of non-flammable plates in accordance with any of the embodiments disclosed herein; and

FIG. 5 illustrates various components of the apparatus shown in FIGS. 1A-1D in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments of the disclosure are directed to apparatuses that provide for prescribed burns of land containing various forms of vegetative ground fuels. Particular embodiments are directed to apparatuses that provide for prescribed burns of forested and agricultural land. Embodiments of the disclosure provide superior prevention against wildfires, and make prescribed burns accessible to individual landowners and government agencies. Embodiments of the disclosure provide for prescribed burns that are safer, cleaner and cheaper than known approaches, and are scalable to meet the critical and increasing global need.

There is growing recognition that prescribed burns are an effective ground fuel management strategy and an emerging policy emphasis on using more ‘good fire’ on public lands by bolstering and developing the capacities of a prescribed burning workforce. This policy commitment has yielded long overdue recognition of the need to forge partnerships with tribal leaders to enhance knowledge and capacities for prescribed burning.

While there is emerging consensus around the need for greater capacity and a larger, well-trained workforce for prescribed burns, it remains unclear how swiftly policy changes can scale to meet the need to treat over 200 million acres of high fire risk forests from today's current capacity of 3 million acres. There are also tactical issues with making prescribed burns safer, cleaner and cheaper. Even with a larger and more skilled prescribed burn workforce, prescribed burns still run the risk of escaped fires, smoke hazard, and resulting carbon emissions, while placing the burden of hiring burn crews on private landowners, many of whom are low-income, elderly or disabled. Prescribed burns are also dependent on short and fast-changing burn windows and have restrictions based on terrain, ecology, and landscape conditions.

Prescribed burns today require extensive pre-planning, including identifying sites, creating fire breaks, and then igniting large areas by hand using drip torches, monitoring the burn as it spreads on its own with little to keep the spread in check, and finally ensuring that all fire and embers are extinguished. Under the current approach, prescribed burns will remain out of reach to many private land and forest owners/managers.

Embodiments of the disclosure are directed to an automated platform that can conduct highly controlled, all-weather prescribed burns on a variety of terrain. For convenience, this automated platform is referred to herein as a Prescribed Burn (PB) platform. Similar to a Zamboni® machine or a lawn tractor, the PB platform processes only the enclosed, limited region directly below it, allowing the PB platform to safely and precisely burn areas at the tree lines, directly adjacent to homes, structures, or other high value assets.

Additional applications of a PB platform include backburning operations for wildfire suppression, “blacklining” to create a pre-burned fire break around a much larger area that will later be burned using conventional prescribed burn methods (such as using drip torches or drones dropping incendiary devices (e.g., fire balls)) as a way of burning very large areas faster, but much more safely and clean stubble burning of spent or unwanted crops which can help rejuvenate the soil in farmland and agroforestry. For example, the PB platform can perform a blacklining operation to create a pre-burned fire break around a parcel of land. The PB platform can create additional fire break stripes within the fire break perimeter (e.g., in a checkerboard pattern) to isolate the vegetative ground fuel in smaller regions within the fire break perimeter. The vegetative ground fuel in the smaller regions can be burned using drip torches or drones dropping incendiary devices.

In some implementations, ignition of the unwanted ground fuels is conducted using an ignition source, such as an array of high-temperature torches. Flames and embers created by the PB platform are fully contained within a “fire box” region (referred to herein as a “burn chamber”) to eliminate the risk of escape fire. The high burn temperature creates less smoke than existing methods such as drip torches, which use noxious accelerants such as diesel fuel or gasoline. The high-temperature torches with long flames also burn the smoke particles produced inside the burn chamber which further reduces the smoke. The PB platform can be configured to carry compressive rollers to break down and compress any partially burned material to reduce oxygenation and, therefore, future risk of ignition.

The PB platform can perform prescribed burns in dry conditions and also operate at night and at times, and in weather conditions, which would otherwise be off limits with current methods. The PB platform brings automation to today's labor-intensive prescribed burning, making them safer, cleaner, cheaper and scalable to meet the urgent need for large-scale fuel management and prevent mega wildfires.

Embodiments of the disclosure are defined in the claims. However, below there is provided a non-exhaustive listing of non-limiting examples. Any one or more of the features of these examples may be combined with any one or more features of another example, embodiment, or aspect described herein.

Example Ex1. An apparatus configured to perform a prescribed burn of vegetative ground fuel comprises a movable platform configured to traverse ground that contains the vegetative ground fuel, a burn chamber disposed on the movable platform, a discharge apparatus configured to expel residual effluent from the burn chamber, and a containment arrangement situated relative to the burn chamber and configured to confine burning of the vegetative ground fuel to a prescribed burn region of the ground. The containment arrangement comprises an arrangement of interleaved plates having two or more different shapes and connected together via link members.

Example Ex2. The apparatus of Ex1, wherein the arrangement of interleaved plates comprises alternating rows of the plates having the two or more different shapes.

Example Ex3. The apparatus of Ex1, wherein the two or more different shapes comprise two or more polygonal shapes.

Example Ex4. The apparatus of Ex3, wherein the plates having a first polygonal shape are larger than the plates having a second polygonal shape.

Example Ex5. The apparatus of Ex1, wherein the two or more different shapes comprise at least a hexagonal shape and a diamond shape.

Example Ex6. The apparatus of Ex5, wherein the plates having the hexagonal shape are larger than the plates having the diamond shape.

Example Ex7. The apparatus of Ex1, wherein the plates comprise stainless steel.

Example Ex8. The apparatus of Ex1, wherein the link members comprise rings.

Example Ex9. The apparatus of Ex1, wherein the link members comprise stainless steel.

Example Ex10. The apparatus of Ex1, wherein the two or more different shapes comprise a hexagonal shape and a diamond shape, and plates having the diamond shape are connected to four adjacent plates having the hexagonal shape.

Example Ex11. The apparatus of Ex1, wherein plates closest to the ground are thicker than plates further from the ground.

Example Ex12. The apparatus of Ex1, wherein plates closest to the ground are thicker than plates further from the ground by about a factor of 1.5 to 2.

Example Ex13. An apparatus configured to perform a prescribed burn of vegetative ground fuel comprises a movable platform configured to traverse ground that contains the vegetative ground fuel, the movable platform comprising a front end and a rear end opposing the front end; a burn chamber disposed on the movable platform, the burn chamber comprising a front end, a rear end opposing the front end, a first side, and a second side opposing the first side; a discharge apparatus configured to expel residual effluent from the burn chamber; and a containment arrangement situated relative to the burn chamber and configured to confine burning of the vegetative ground fuel to a prescribed burn region of the ground. The containment arrangement comprises a front skirt situated proximate the front end of the burn chamber, a rear skirt situated proximate the rear end of the burn chamber, a first side skirt situated proximate the first side of the burn chamber, and a second side skirt situated proximate the second side of the burn chamber. A plurality of rollers are situated at the rear end of the movable platform, the plurality of rollers comprising a first end roller and a second end roller opposing the first end roller. A first roller skirt is situated proximate the rear skirt, a first extender skirt is situated rearward of the first roller skirt and proximate the first end roller, and a second extender skirt is situated rearward of the first roller skirt and proximate the second end roller. Each of the respective skirts comprises an arrangement of interleaved plates having two or more different shapes and connected together via link members.

Example Ex14. The apparatus of Ex13, wherein the arrangement of interleaved plates comprises alternating rows of the plates having the two or more different shapes.

Example Ex15. The apparatus of Ex13, wherein the two or more different shapes comprise two or more polygonal shapes.

Example Ex16. The apparatus of Ex15, wherein the plates having a first polygonal shape are larger than the plates having a second polygonal shape.

Example Ex17. The apparatus of Ex13, wherein the two or more different shapes comprise at least a hexagonal shape and a diamond shape.

Example Ex18. The apparatus of Ex17, wherein the plates having the hexagonal shape are larger than the plates having the diamond shape.

Example Ex19. The apparatus of Ex13, wherein the plates comprise stainless steel.

Example Ex20. The apparatus of Ex13, wherein the link members comprise rings.

Example Ex21. The apparatus of Ex13, wherein the link members comprise stainless steel.

Example Ex22. The apparatus of Ex13, wherein the two or more different shapes comprise a hexagonal shape and a diamond shape, and plates having the diamond shape are connected to four adjacent plates having the hexagonal shape.

Example Ex23. The apparatus of Ex13, wherein plates closest to the ground are thicker than plates further from the ground.

Example Ex24. The apparatus of Ex13, wherein plates closest to the ground are thicker than plates further from the ground by about a factor of 1.5 to 2.

Example Ex25. The apparatus of Ex13, comprising one or more restraint members attached to each of the first and second side skirts, the one or more restraint members configured to constrain movement of the first and second side skirts during operation of the apparatus.

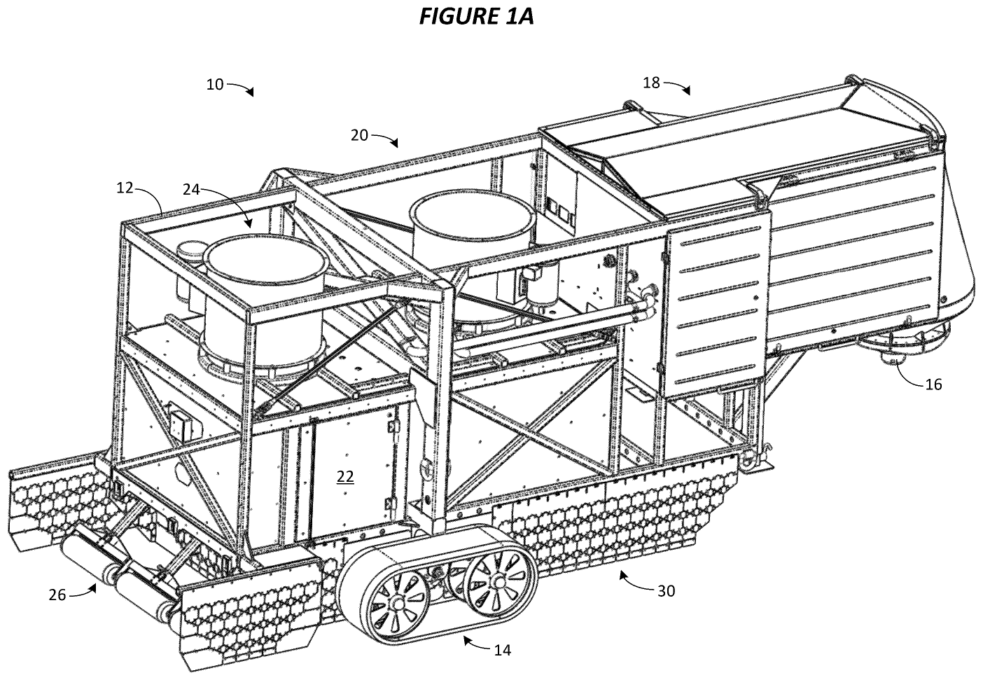

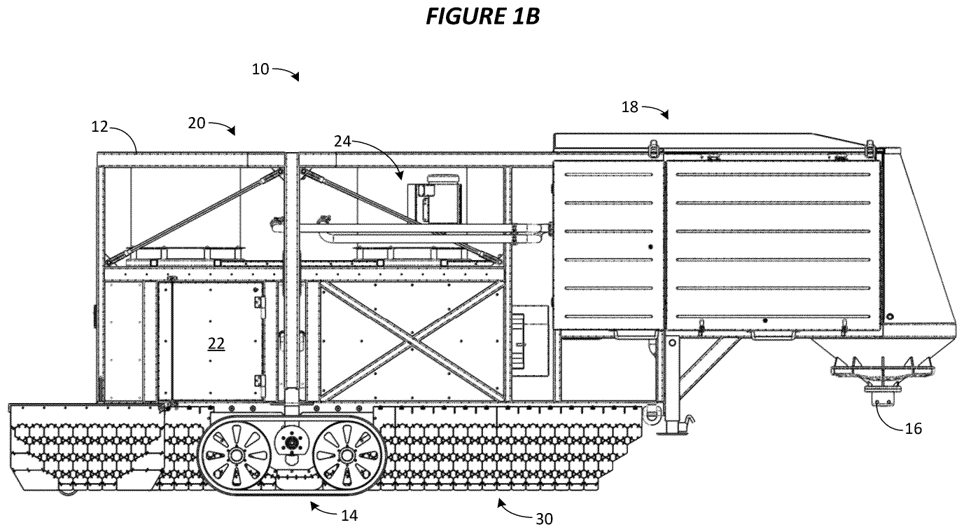

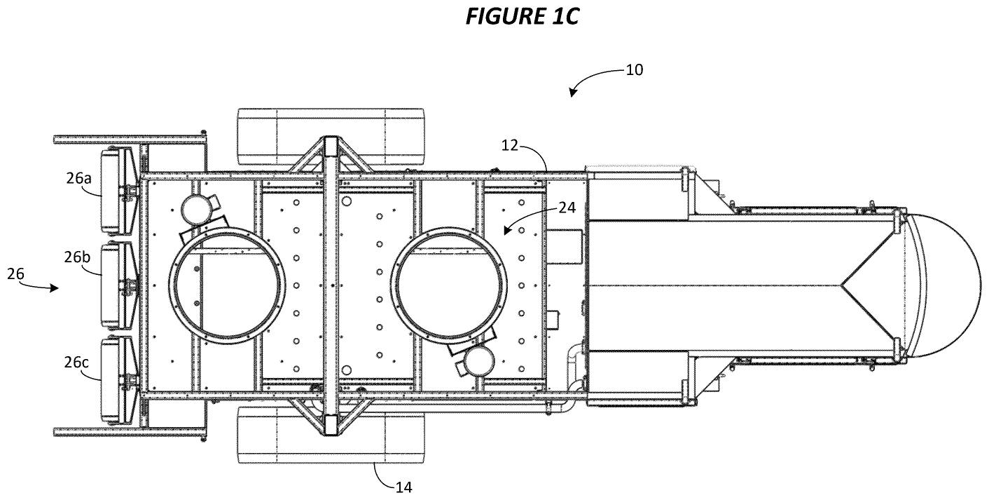

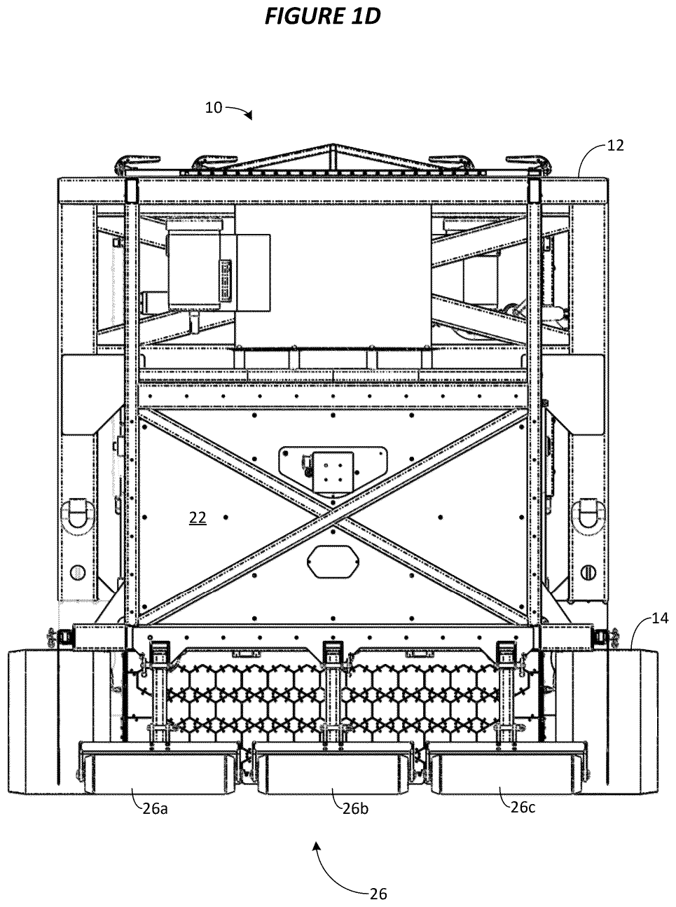

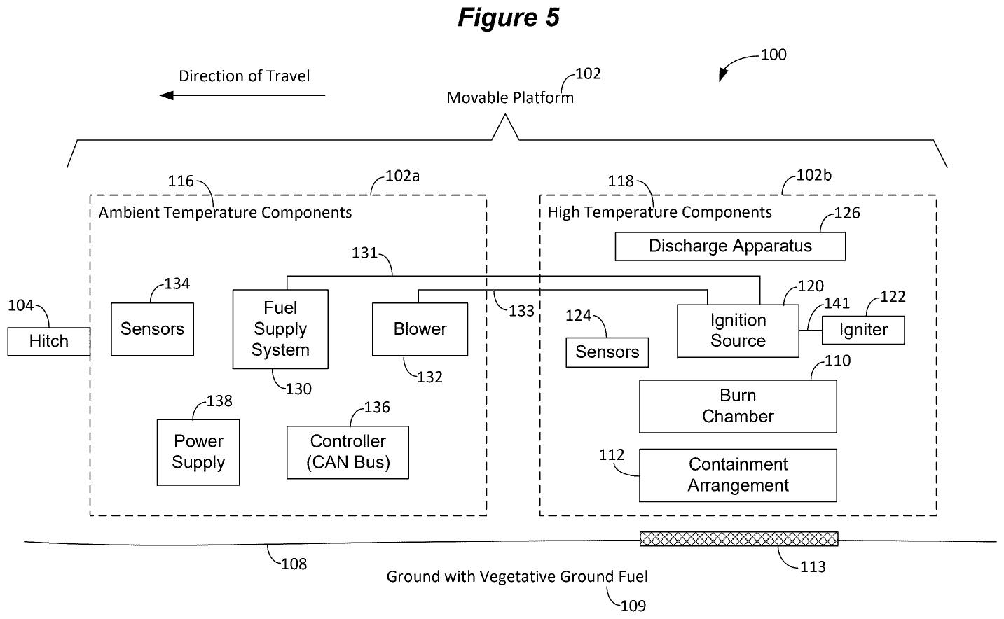

FIGS. 1A-1D are views showing details of a PB platform 10 in accordance with any of the embodiments disclosed herein. The PB platform 10 includes a frame 12 which supports the PB platform components. The frame 12 supports a track arrangement 14 and a hitch 16, which allow the PB platform 10 to be towed by a tow vehicle (e.g., an autonomous tow vehicle). The PB platform 10 components supported by the frame 12 include a number of ambient-temperature components 18 and a number of high-temperature components 20. Examples of the ambient- and high-temperature components 18, 20 are shown in FIG. 5 and described in the accompanying text below.

The high-temperature components 20 include a burn chamber 22 which houses a number of ignition sources (e.g., torches). It is understood that the burn chamber 22 is devoid of a bottom so that flames produced by the torches reach the vegetative ground fuel below the burn chamber 22. The high-temperature components 20 also include a discharge apparatus 24 configured to expel residual effluent from the burn chamber 22. As shown, the discharge apparatus 24 includes two high-CFM extractor fans that expel residual effluent from the burn chamber 22.

As is best seen in FIGS. 1C and 1D, the PB platform 10 includes a number of rollers 26 at the rear of the PB platform 10 proximate the rear end of the burn chamber 22. As illustrated, the PB platform 10 includes three rollers 26a, 26b, and 26c. It is understood the more or fewer than three rollers 26 can be supported by the PB platform 10. The compressive rollers 26 break down and compress any partially burned material to reduce oxygenation and, therefore, future risk of ignition.

The PB platform 10 includes a non-flammable skirt arrangement 30 attached to a lower portion of the frame 12. The skirt arrangement 30 includes skirts that extend from the lower portion of the burn chamber 22 to about ground level. An air gap is provided between the skirt arrangement 30 and the ground (about the perimeter of the burn chamber 22) that can be selected to match the flow rate of the extractor fans of the discharge apparatus 24 so the inward air flow velocity serves to contain the flames and embers within the burn chamber 22. The skirt arrangement 30 also includes skirts situated proximate the rollers 26.

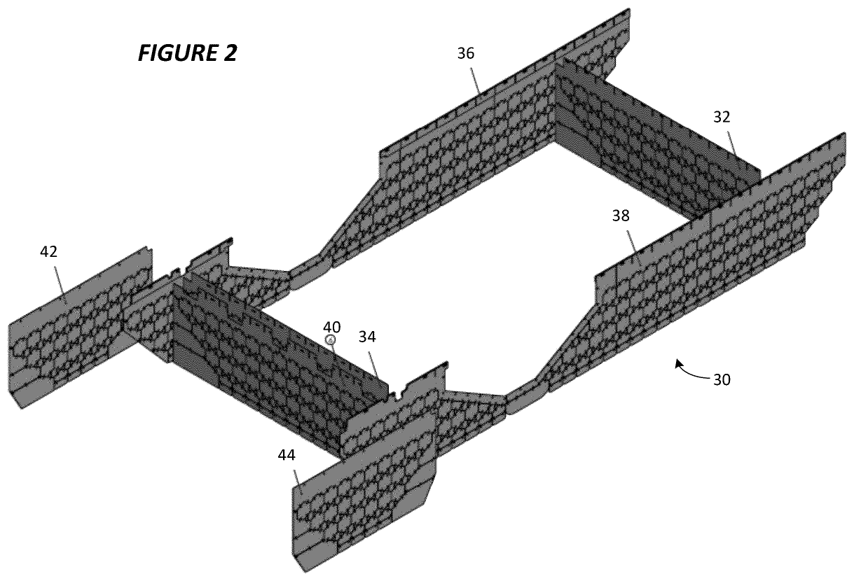

FIG. 2 illustrates the skirts that are components of the skirt arrangement 30 shown in FIGS. 1A-1D. Although not show in FIG. 2, the burn chamber 22 includes a front end, a rear end opposing the front end, a first side, and a second side opposing the first side. The skirt arrangement 30 incudes a front skirt 32 situated proximate the front end of the burn chamber 22, a rear skirt 34 situated proximate the rear end of the burn chamber 22, a first side skirt 36 situated proximate the first side of the burn chamber 22, and a second side skirt 38 situated proximate the second side of the burn chamber 22.

The rollers 26, a best seen in FIGS. 1C and 1D, include a first end roller 26a and a second end roller 26c opposing the first end roller 26a. A first roller skirt 40 is situated proximate the rear skirt 34. A first extender skirt 42 is situated rearward of the first roller skirt 40 and proximate the first end roller 26a. A second extender skirt 44 is situated rearward of the first roller skirt 40 and proximate the second end roller 26c. Each of the respective skirts 32-44 comprises an arrangement of interleaved non-flammable plates having two or more different shapes and connected together via link members.

In some implementations, the first and second side skirts 36, 38 may be susceptible to being sucked inwardly by the inrush of air caused by the extractor fans of the discharge apparatus 24. The first and second side skirts 36, 38 may be susceptible to hanging into or away from the burn chamber 22 when the PB platform 10 is on a side slope. If the first and second side skirts 36, 38 tilt inward or outward too much, this tilt will create an opening at the bottom that can allow fire to escape out the sides of the PB platform 10. Also, if the tilt is inward, the plates of the skirt arrangement 30 can interfere with the torches within the burn chamber 22 that are closest to the sides of the PB platform 10.

One or more restraint members can be attached to the external surface of the first and second side skirts 36, 38 that constrain the inward and outward movement of the first and second side skirts 36, 38. The restraint members can extend at an angle from a location near the top of the first and second side skirts 36, 38 to a location near the bottom of the first and second side skirts 36, 38. The restraint members can include a lower coil spring member having a loop shape that extends from near the bottom of the first and second side skirts 36, 38 to near a mid-point of the first and second side skirts 36, 38. The restraint members can also include a small upper coil spring member having a loop shape near the top of the first and second side skirts 36, 38. A rigid or flexible member can extend between the lower and upper coil spring members. The lower and upper coil spring members allow the restraint members to flex in any direction, while providing sufficient constraint of the movement of the first and second side skirts 36, 38. In some implementations, chains can be provided in the burn chamber 22 that attach near the center of the burn chamber 22 and to one or more locations on the inside surface of the first and second side skirts 36, 38 for additional constraint.

Another approach to constraining movement of the first and second side skirts 36, 38 involves the use of a thin stainless steel cable that runs through the link members (e.g., rings) that hold the bottom plates to the next row above, and to have spring(s) that create tension in that cable. The spring tension can be created by arms that have a torsion spring to angle them away from each other, or from an anchor point at the other end of the cable, for example.

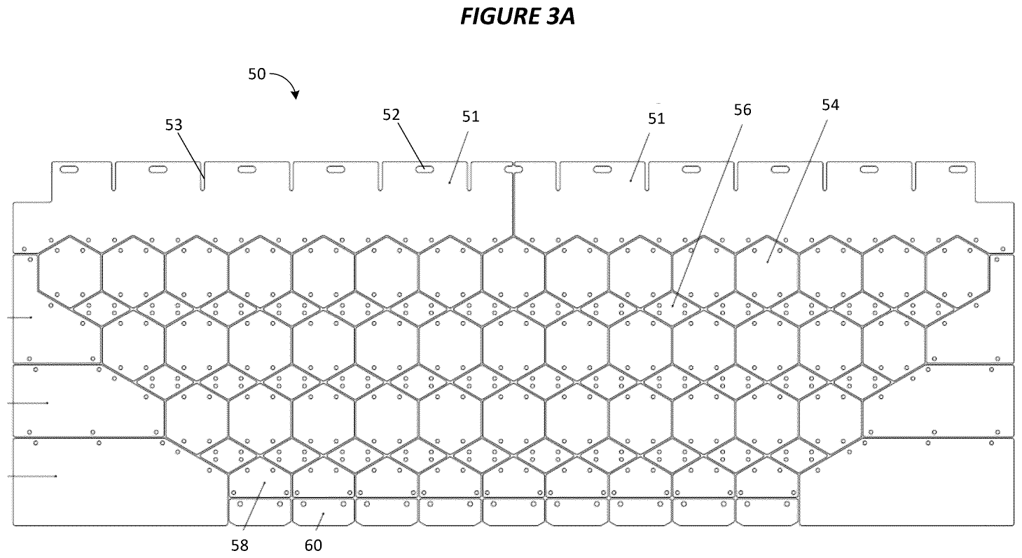

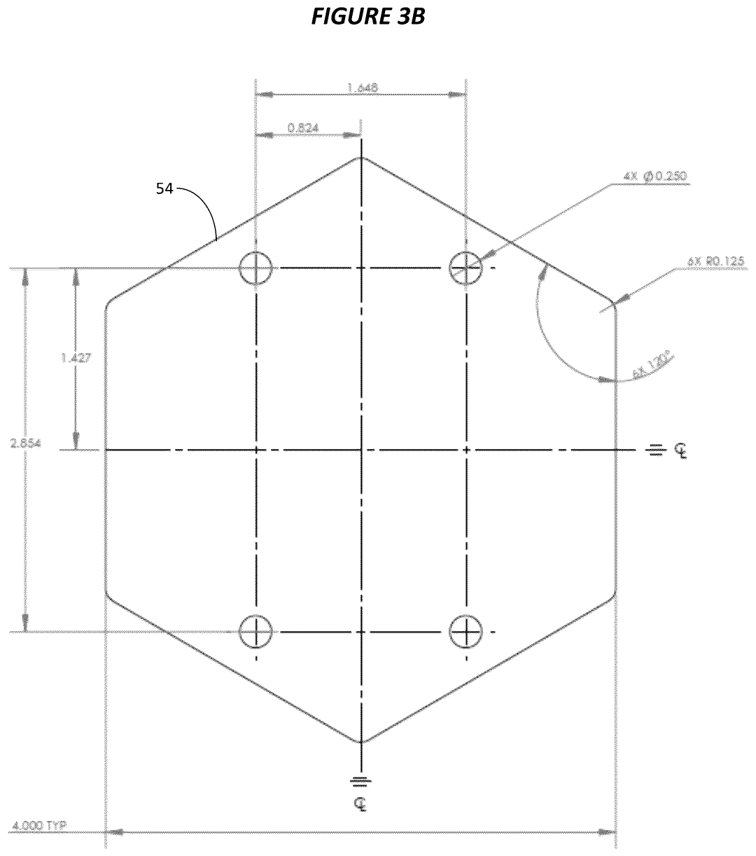

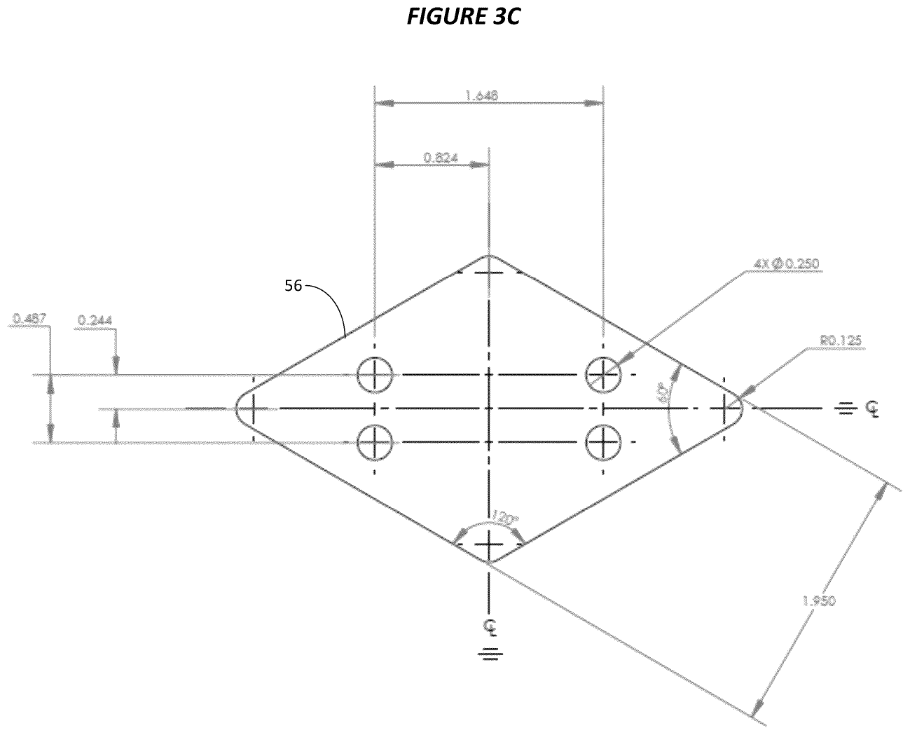

FIG. 3A illustrates a representative skirt of the skirt arrangement 30 shown in FIG. 2. The skirt 50 shown in FIG. 3A is fabricated using a non-flammable material, such as stainless steel (e.g., 303, 304, 316 stainless steel). Other non-flammable materials can be used, such as titanium, tungsten, Inconel or ceramic material.

The skirt 50 is attached to the frame 12 of the PB platform 10 using mounting bolts that pass through slots 52 of frame plates 51, which are received by holes in the tubular frame 12. In some implementations, the lower tubular frame 12 proximate the burn chamber 22 can have oversized holes with stainless steel inserts welded into them with smaller through holes for the mounting bolts, with a square step on the back side to accommodate carriage bolts.

The horizontal slots 52 of the frame plates 51 provide a degree of lateral freedom. The vertical slots 53 of the frame plates 51 add a degree of relief to help reduce warping of the frame plates 51 due to thermal expansion under high heat load during burning.

The skirt 50 includes an arrangement of interleaved plates 54, 56 having different shapes. In the representative embodiment shown in FIG. 3A, plates 54 have a hexagonal shape and plates 56 have a diamond shape. The hexagonal plates 54 are larger than the diamond plates 56. Rows of the diamond plates 56 are offset from, and disposed between, rows of the hexagonal plates 54 to define an interleaved pattern of plates 54, 56. Although the skirt 50 includes plates having two different shapes (e.g., two different polygonal shapes), plates having more than two different shapes can be employed.

FIG. 3B shows a representative hexagonal plate 54, with dimensions expressed in terms of inches. FIG. 3C shows a representative diamond plate 56, with dimensions expressed in terms of inches. The hexagonal and diamond plates 54, 56 include two top holes and two bottom holes. The top holes of a diamond plate 56 facilitate connection to bottom holes of an adjacent hexagonal plate 54 via link members. The bottom holes of a diamond plate 56 facilitate connection to top holes of an adjacent hexagonal plate 54 via link members.

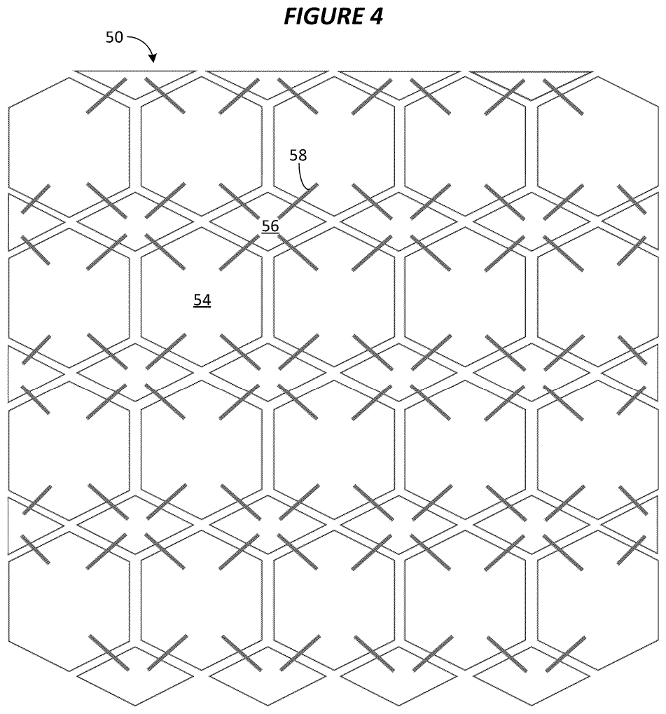

FIG. 4 is a depiction of a portion of skirt 50 showing hexagonal plates 54 connected to diamond plates 56 via link members 58. The link members 58 comprise a non-flammable material, such as stainless steel. The link members 58 are preferably rings that pass through the holes provided in the hexagonal and diamond plates 54, 56. In accordance with one installation approach, the link members 58 are originally split stainless steel rings which are TIG welded once they are assembled with the plates 54, 56, and are bent back to close the split.

Referring again to FIG. 3A, the skirt 50 includes a bottom row of plates 60 which are attached to transitional plates 58. The bottom plates 60, which are closest to the ground, are preferably heavier than the plates 54, 56 situated above the bottom plates 60. For example, the bottom plates 60 can be thicker (and therefore heavier and stronger) than the plates 54, 56 situated above the bottom plates 60 by a factor of 1.5-2. The added weight of the bottom plates 60 helps them push through the vegetation. For skirts 50 disposed proximate the burn chamber 22, the added weight of the bottom plates 60 serves to hold the skirt 50 down against the forceful inrush of air caused by the fans of the discharge apparatus 24.

FIG. 5 illustrates an apparatus configured to perform a prescribed burn of vegetative ground fuel in accordance with any of the embodiments disclosed herein. The apparatus illustrated in FIG. 5 and other figures can include some or all of the structures, components, and functionality disclosed in U.S. Patent Application Publication No. 2022/0412553, which is incorporated herein by reference in its entirety. The components of the apparatus shown in FIG. 5 can be included in the PB platform illustrated in FIGS. 1A-1D.

The apparatus shown in FIG. 5 is referred to herein as a PB apparatus 100 which includes a movable platform 102 (e.g., a PB platform) configured to transport components of the apparatus over land 108 which contains vegetative ground fuel 109. The vegetative ground fuel 109 can be any type of vegetative material including, but not limited to, leaves, needles, twigs, brush, small branches, weeds, grass, shrubbery, and agricultural material (e.g., stalks, dead plantings, vegetable material, fruit material). The PB apparatus 100 is configured to traverse ground 108 comprising vegetative ground fuel 109 and perform a prescribed burn of the vegetative ground fuel 109 within a prescribed burn region without a human directly intervening in the prescribed burn. It is understood that, although some embodiments involve hitching a vehicle (e.g., ATV, truck, tractor) to the PB apparatus 100 and/or driving said vehicle, the prescribed burn itself does not require human intervention.

As is shown in FIG. 5, the movable platform 102 supports a number of ambient temperature components 116 and a number of high-temperature components 118. The movable platform 102 includes a hitch 104 configured to hitch the movable platform 102 to a tow vehicle (e.g., an autonomous tow vehicle). It is understood that the hitch 104 can include electrical, mechanical, fluidic, and/or hydraulic interconnects in addition to a hitch mechanism.

The high-temperature components 118 include a burn chamber 110 disposed on the movable platform 102. An ignition source 120 is disposed in the burn chamber 110 and configured to ignite vegetative ground fuel 109 within a prescribed burn region 113 on the ground 108. The prescribed burn region 113 defines a region of ground immediately below the burn chamber 110. In other words, the prescribed burn region 113 of the ground 108 is coextensive in area to an area circumscribed by the burn chamber 110.

In various implementations, the movable platform 102 is moved on a continuous basis and at a speed which allows completion of a prescribed burn of ground within the prescribed burn region 113 of the burn chamber 110. As such, vegetative ground fuel 109 which enters the burn chamber 110 is completely burned and rendered inert upon leaving the burn chamber 110. In this manner, the prescribed burn region 113 grows as the burn chamber 110 is moved along the ground 108 as the movable platform 102 traverses the ground 108.

As is also shown in FIG. 5, a containment arrangement 112 is situated relative to the burn chamber 110. As is described hereinabove, the containment arrangement 112 is configured to confine burning of the vegetative ground fuel 109 to the prescribed burn region 113 of the ground 108. A discharge apparatus 126 is positioned relative to the burn chamber 110. The discharge apparatus 126 is configured to expel residual effluent (e.g., residual smoke, greenhouse gasses) from the burn chamber 110. The discharge apparatus, which can include a high-CFM fan or fans, aids with containment of flames and embers by creating an inward airflow at the bottom perimeter of the burn chamber 110. Various sensors 124, 134, examples of which are discussed below, can be provided to monitor the various ambient and high temperature components 116, 118 and the current environmental conditions of the prescribed burn (e.g., local wind speed, ambient temperature, humidity).

The ignition source 120 can be implemented as any type of heat source that generates heat sufficient to burn vegetative ground fuel 109. In some implementations, the ignition source 120 includes a multiplicity (e.g., an array or arrays) of torches 120 each coupled to an igniter 122. The igniter 122 comprises at least one of an electrical discharge igniter, an RF heater, a microwave heater, a laser, and a chemical igniter. The array of torches 120 can be arranged as a single dimensional (e.g., along an x axis) array or a multi-dimensional (e.g., along x and y axes) array. Other ignition sources 120 are contemplated, including a heating filament coupled to an electrical power source and a pilot flame arranged to be ignited by fuel delivered to the burn chamber 110 via a fuel supply system 130 (e.g., a fuel spray arrangement).

According to any of the embodiments which include a multiplicity of torches 120, the torches 120 are situated within the burn chamber 110 and are configured to ignite vegetative ground fuel within a prescribed burn region 113 of the ground 108. In some implementations, all of the torches 120 are directed towards the ground 108. In other implementations, a first set of the torches 120 are directed towards the ground 108, and a second set of torches 120 are directed away from the ground and configured to burn smoke captured within the burn chamber 110. Using torches 120 to burn smoke captured within the burn chamber 110 advantageously reduces the amount of noxious effluent expelled from the burn chamber 110. It is noted that even the torches 120 pointed at the ground also burn the smoke. For example, the torches 120 can produce a long flame such that the hottest part of the torch flame (e.g., the tip of the light blue cone) is above the ground, and is in a position to interact with the rising smoke from the burning vegetation. The torches 120 can have a configuration as disclosed in previously incorporated U.S. Patent Application Publication No. 2022/0412553 (see, e.g., FIGS. 1A-1D).

A fuel supply line 131 is configured to transport a fuel, such as propane gas, from a fuel supply system 130 (e.g., which includes a pressurized fuel tank or tanks) to the torches 120. The fuel supply system 130 can supply gaseous fuel at a specified flow rate. It is understood that the fuel flow rate will vary based on several factors, including the length and diameter of the torches 120, the length of the flames, and the temperature of the flames, among others.

An air supply line 133 is configured to transport air from a blower 132 to air inlets of the torches 120. The blower 132 is important because the torches 120 are inside the burn chamber 110, and cannot use smokey, dirty air drawn directly from the burn chamber 110. It is noted that having a separately controllable supply of oxygen (air) to the torches 120 with a separately controllable gas supply allows for widely adjustable torch flame temperature, and flame length as needed for various types and densities of vegetation, and burn requirements.

The blower 132 can supply air to the manifold 203 at a specified flow rate. It is understood that the air flow rate will vary based on several factors, including the length and diameter of the torches 120, the length of the flames, and the temperature of the flames, among others. Together, the fuel supply system 130 and the blower 132 are configured to transport fuel and air through the torches 120 at a specified flow rate in order to produce a flame at the torch head having a specified length and/or temperature.

In general, flames produced by the torches 120 are relatively long flames. Typical flames produced by the torches 120 have a length, L, of about 1 foot to about 3 feet. Those with ordinary skill in the art will appreciate that producing sustained flames having a length of about 1 foot to about 3 feet from a torch is a difficult challenge. Flames having a long length are needed to reach deep into thick vegetative growth/fuel and to provide adequate clearance between the terminal ends of the torches 120 and vegetative ground fuel 109 contained on the ground 108. In addition, the long flame delivers high heat into the space above the vegetative growth which burns the ash and smoke particles, thereby reducing the smoke production before any filtering is performed. Length and temperature of the flames are variable. For example, the temperature of the flames can be varied between about 500° F. to about 3600° F.

As is further shown in FIG. 5, the ambient temperature components 116 include a power supply 138 (e.g., a generator), various sensors 134, and a controller 136. The controller 136 is configured to execute computer readable instructions (e.g., software and/or firmware) for controlling the operation of the ambient and high temperature components 116, 118 of the PB apparatus 100. In some implementations, the controller 136 can be a logic processing component of a Controller Area Network (e.g., a CAN bus).

A wide variety of sensors 134 can be supported by the movable platform 102 for monitoring various processes and conditions of the PB vehicle 300. The array of sensors 134 can include one or any combination of one or more temperature sensors, humidity sensor, air flow rate, fuel flow rate, air pressure, fuel pressure (PSI) sensors, particulate matter sensor, one or more gas sensors/analyzers, a location sensor (e.g., a GPS, GPS-RTK), and optical/vision/imaging sensors (e.g., a camera positioned to view the burn chamber/torch flames via a Pyrex® window). In the case of an autonomous vehicle implementation, the sensors 134 can include autonomous vehicle proximity and ranging sensors, such as radar, sonar, ultrasound, and LIDAR.

The following is a non-exhaustive list of additional sensors that may be incorporated in the movable platform 102 in accordance with any of the embodiments disclosed herein. As previously discussed, the sensors 134 can include temperature sensors (e.g., multiple, in various locations inside and outside of the burn chamber 110), which can include one or more thermocouples, IR remote sensors, thermistors, RTD (Resistive Temperature Detection) sensors, and bi-metal sensors. One or more sensors can be implemented to monitor and aid in control of torch temperature, monitor burn chamber temperature, monitor fuel (vegetation), and soil temperature before, during and after a prescribed burn. Temperature sensors can be deployed to monitor temperature of various components including, but not limited to, torch components, burn chamber sides, fan temperature, and temperature of expelled gasses.

The sensors 134 can include one or more smoke particulate emission sensors, such as PM 2.5 and PM 10 sensors. The sensors 134 can include one or more greenhouse gas emission sensors, such as CO, CO2, and methane sensors. Various chemical effluence sensors can also be deployed.

The sensors 134 can include one or more optical sensors and IR cameras (e.g., multiple, in various locations. The optical sensors and IR cameras can be implemented to monitor torch performance (e.g., torch flame length and temperature (colorimetry)), monitor and record vegetation flame height, consistency and other flame properties, evaluate completeness of the burn (e.g., fuel consumption), and check for left-over flames or embers to extinguish.

Various sensors 134 can be included for controlling and tracking movable platform position and motion, such as for remote or autonomous control. As previously discussed, such sensors 134 can include one or more of optical and IR cameras, radar, LIDAR, ultrasonic sensors, GPS, inertial navigation (gyros, MEMS, laser, or spinning), and an odometer.

The sensors 134 can include one or more moisture and other fuel (vegetation) property sensors. Such sensors 134 can include multispectral or hyperspectral imaging cameras, microwave sensors, and RF sensors. These and other sensors can be implemented to measure moisture level in the fuel (vegetation), moisture in the soil, and moisture in the atmosphere within and outside of the burn chamber 110.

The sensors 134 can also include one or more other sensors, such as flow meters for air and gas input to torches and pressure gauges for the air blower and gas lines, a fan speed tachometer, an air flow sensor, an anemometer/weathervane to monitor external wind speed and direction, an outside air temperature sensor, and an outside humidity sensor.

Any or all of the data collected by the various sensors 134 can be stored in the memory coupled to the controller 136. Any or all of the data collected by the various sensors 134 can be stored in a central server communicatively coupled to the controller 136 (e.g., accessed via a wireless transceiver and a network access point coupled to the Internet) to be accessed by fire departments, the USGS, the EPA and other public and private agencies, and can also be correlated with mapping services such as Google Geospatial.

The sensors 134 are operatively coupled to, and monitored by, the controller 136. The controller 136, which can be a computer, processor or other logic device, can be configured to control and adjust any of the processes implemented by the ambient and high-temperature components 116, 118 of the movable platform 102. For example, the controller 136 can be configured to adjust the speed/CFM of the blower 132 and/or pressure/flow rate of the fuel supply system 130 to produce torch flames of a prescribed length (e.g., 2 feet or 3 feet in length) and/or temperature, and control fan speed, etc. The controller 136 can either be implemented as, or be communicatively coupled to, a central computer system which can also log all the data from the sensors 134, and provide a dashboard that is continuously updated. Data acquired by the controller 136 can be communicated to an external electronic device (e.g., a tablet, laptop, smartphone), which can display the data to the operator of the movable platform 102.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. An apparatus configured to perform a prescribed burn of vegetative ground fuel, comprising:
a movable platform configured to traverse ground that contains the vegetative ground fuel;
a burn chamber disposed on the movable platform;
a containment arrangement situated relative to the burn chamber and configured to confine burning of the vegetative ground fuel to a prescribed burn region of the ground, the containment arrangement comprising an arrangement of interleaved plates having two or more different shapes and connected together via link members; and
a discharge apparatus configured to expel residual effluent from the burn chamber.

2. The apparatus of claim 1, wherein the arrangement of interleaved plates comprises alternating rows of the plates having the two or more different shapes.

3. The apparatus of claim 1, wherein the two or more different shapes comprise two or more polygonal shapes.

4. The apparatus of claim 3, wherein the plates having a first polygonal shape are larger than the plates having a second polygonal shape.

5. The apparatus of claim 1, wherein the two or more different shapes comprise at least a hexagonal shape and a diamond shape.

6. The apparatus of claim 5, wherein the plates having the hexagonal shape are larger than the plates having the diamond shape.

7. The apparatus of claim 1, wherein the plates comprise stainless steel.

8. The apparatus of claim 1, wherein the link members comprise rings.

9. The apparatus of claim 1, wherein the link members comprise stainless steel.

10. The apparatus of claim 1, wherein:
the two or more different shapes comprise a hexagonal shape and a diamond shape; and
plates having the diamond shape are connected to four adjacent plates having the hexagonal shape.

11. The apparatus of claim 1, wherein plates closest to the ground are thicker than plates further from the ground.

12. The apparatus of claim 1, wherein plates closest to the ground are thicker than plates further from the ground by about a factor of 1.5 to 2.

13. An apparatus configured to perform a prescribed burn of vegetative ground fuel, comprising:
a movable platform configured to traverse ground that contains the vegetative ground fuel, the movable platform comprising a front end and a rear end opposing the front end;
a burn chamber disposed on the movable platform, the burn chamber comprising a front end, a rear end opposing the front end, a first side, and a second side opposing the first side;
a containment arrangement situated relative to the burn chamber and configured to confine burning of the vegetative ground fuel to a prescribed burn region of the ground, the containment arrangement comprising a front skirt situated proximate the front end of the burn chamber, a rear skirt situated proximate the rear end of the burn chamber, a first side skirt situated proximate the first side of the burn chamber, and a second side skirt situated proximate the second side of the burn chamber;
a plurality of rollers situated at the rear end of the movable platform, the plurality of rollers comprising a first end roller and a second end roller opposing the first end roller;
a first roller skirt situated proximate the rear skirt;
a first extender skirt situated rearward of the first roller skirt and proximate the first end roller;
a second extender skirt situated rearward of the first roller skirt and proximate the second end roller; and
a discharge apparatus configured to expel residual effluent from the burn chamber;
wherein each of the respective skirts comprises an arrangement of interleaved plates having two or more different shapes and connected together via link members.

14. The apparatus of claim 13, wherein the arrangement of interleaved plates comprises alternating rows of the plates having the two or more different shapes.

15. The apparatus of claim 13, wherein the two or more different shapes comprise two or more polygonal shapes.

16. The apparatus of claim 15, wherein the plates having a first polygonal shape are larger than the plates having a second polygonal shape.

17. The apparatus of claim 13, wherein the two or more different shapes comprise at least a hexagonal shape and a diamond shape.

18. The apparatus of claim 17, wherein the plates having the hexagonal shape are larger than the plates having the diamond shape.

19. The apparatus of claim 13, wherein the plates comprise stainless steel.

20. The apparatus of claim 13, wherein the link members comprise rings.

21. The apparatus of claim 13, wherein the link members comprise stainless steel.

22. The apparatus of claim 13, wherein:
the two or more different shapes comprise a hexagonal shape and a diamond shape; and
plates having the diamond shape are connected to four adjacent plates having the hexagonal shape.

23. The apparatus of claim 13, wherein plates closest to the ground are thicker than plates further from the ground.

24. The apparatus of claim 13, wherein plates closest to the ground are thicker than plates further from the ground by about a factor of 1.5 to 2.

25. The apparatus of claim 13, comprising one or more restraint members attached to each of the first and second side skirts, the one or more restraint members configured to constrain movement of the first and second side skirts during operation of the apparatus.
